(19) United States
(12) Patent Application Publication
(10) Pub. No.: US 2025/0175069 A1
(43) Pub. Date: May 29, 2025

(54) LINEAR MOTOR

(71) Applicant: FUJI ELECTRIC CO., LTD., Kanagawa (JP)

(72) Inventor: Terukazu AKIYAMA, Tokyo (JP)

(21) Appl. No.: 18/952,259

(22) Filed: Nov. 19, 2024

(30) Foreign Application Priority Data
Nov. 27, 2023 (JP) 2023-200164

(51) Int. Cl. H02K 41/02

(52) U.S. Cl. CPC H02K 41/02; H02K 2213/03

(57) ABSTRACT

A linear motor includes an armature and a field magnet facing each other such that relative movement is possible. The armature includes a plurality of windings, each of which being wound around a first iron core and arranged along a direction of the relative movement, the field magnet is arranged to face the armature in a direction orthogonal to the direction of the relative movement, and includes a plurality of permanent magnets arranged along the direction of the relative movement, and a plurality of second iron cores arranged to alternate with the permanent magnets along the direction of the relative movement, and a first ratio of a dimension of a portion of the first iron core facing the field magnet with respect to a pitch at which the windings are arranged in the direction of the relative movement, is less than or equal to 0.53.

### CROSS-REFERENCE TO RELATED APPLICATION

The present application is based upon and claims priority to Japanese Patent Application No. 2023-200164, filed on Nov. 27, 2023, the entire contents of which are incorporated herein by reference.

### BACKGROUND OF THE INVENTION

### 1. Field of the Invention

The present disclosure relates to a linear motor.

### 2. Description of the Related Art

For example, sensorless control is known in which the positions of magnetic poles are estimated by using the induced voltage and saliency of the electric motor to control an electric motor without using a position sensor or a speed sensor.

In particular, for linear motors, which operate at relatively lower speeds compared to rotary machines, sensorless control is performed using saliency, because the induced voltage decreases (for example, see Patent Document 1).

### RELATED-ART DOCUMENTS

### Patent Document

[Patent Document 1] Japanese Unexamined Patent Application Publication No. 2016-171669

### SUMMARY OF THE INVENTION

According to an embodiment of the present disclosure, a linear motor includes an armature; and a field magnet, the armature and the field magnet being arranged to face each other such that relative movement is possible, wherein the armature includes a plurality of windings, each of which being wound around a first iron core and arranged along a direction of the relative movement, the field magnet is arranged to face the armature in a direction orthogonal to the direction of the relative movement, and includes a plurality of permanent magnets arranged along the direction of the relative movement, and a plurality of second iron cores arranged to alternate with the permanent magnets along the direction of the relative movement, and a first ratio of a dimension of a portion of the first iron core facing the field magnet with respect to a pitch at which the windings are arranged in the direction of the relative movement, is less than or equal to 0.53.

### BRIEF DESCRIPTION OF THE DRAWINGS

FIG. 1 is a side sectional view illustrating an example of a linear motor;

FIG. 2 is a plan sectional view illustrating an example of an armature;

FIG. 3 is a diagram schematically illustrating an inductance trajectory of a linear motor;

FIG. 4 is a diagram illustrating a change in an inductance trajectory in association with a change in current conditions of a linear motor according to a comparative example;

FIG. 5 is a diagram explaining dimensions of components of a linear motor related to inductance characteristics of the linear motor;

FIG. 6 is a diagram illustrating an example of analysis results concerning the relationship between the ratio of the width of the end portion of the core in the Z-axis direction with respect to the coil pitch and the ratio of the length of the soft magnetic member to the magnetic pole pitch, and the inclination of the inductance trajectory of the linear motor under specific current conditions; and

FIG. 7 is a diagram illustrating a change in an inductance trajectory in association with a change in current conditions of an example of a linear motor.

### DETAILED DESCRIPTION OF THE EMBODIMENTS

The saliency characteristic of the linear motor may change depending on the current condition of the linear motor. For example, under the current condition of a medium load to a high load in which a relatively large current flows, the magnetic saturation of the linear motor becomes prominent and the inductance characteristic changes, and as a result, the saliency characteristic of the linear motor may change. Therefore, due to the change in the saliency characteristic in response to the change in the current condition, the estimation accuracy of the magnetic pole position may decrease, and as a result, the control performance of the linear motor may be degraded.

In view of the above problem, it is an object of the present invention to provide a technology capable of improving the performance of sensorless control of the linear motor from the structural aspect.

According to the present embodiment, the performance of sensorless control of a linear motor can be improved from a structural aspect.

Embodiments will be described below with reference to the drawings.

### [Outline of Linear Motor]

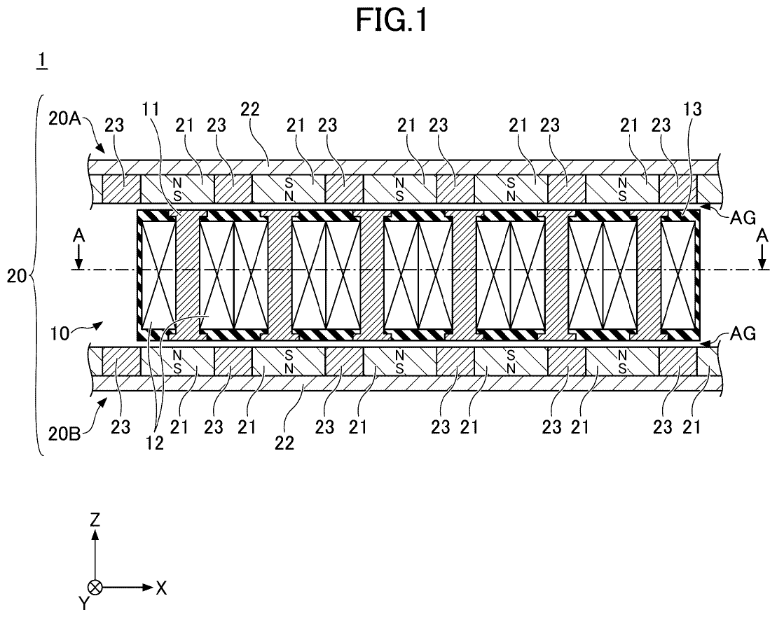

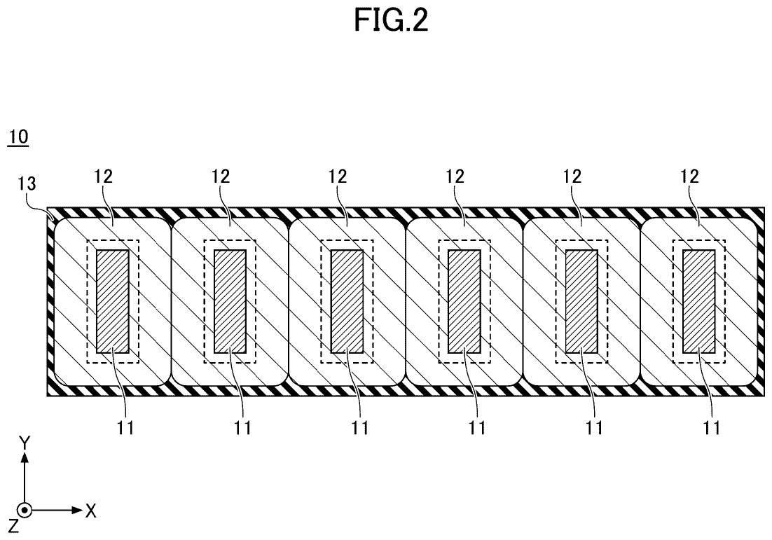

An outline of a linear motor 1 according to the present embodiment will be described with reference to FIGS. 1 and 2.

FIG. 1 is a side sectional view illustrating an example of the linear motor 1. More specifically, FIG. 1 is a sectional view taken in a plane parallel to the X and Z axes of the linear motor 1. FIG. 2 is a plan sectional view illustrating an example of an armature 10. More specifically, FIG. 2 is a sectional view taken along the line A-A in FIG. 1.

Hereinafter, descriptions may be made using a rectangular coordinate system defined by the X, Y, and Z axes in the drawings. In some cases, the positive X-axis direction and the negative X-axis direction are collectively referred to as the X-axis direction, the positive Y-axis direction and the negative Y-axis direction are collectively referred to as the Y-axis direction, and the positive Z-axis direction and the negative Z-axis direction are collectively referred to as the Z-axis direction.

The linear motor 1 according to the present embodiment may be incorporated in the opening and closing mechanism of various sliding doors such as a door of a railway vehicle or a door of a platform of a train station. The linear motor 1 according to the present embodiment may be mounted in a machine tool such as a semiconductor manufacturing apparatus or a machining center.

As illustrated in FIGS. 1 and 2, the linear motor 1 includes an armature 10 and a field magnet 20. In FIG. 1, letters “N” and “S” drawn on the field magnet 20 represent the magnetic poles (N poles and S poles) of a permanent magnet 21. In FIG. 2, dashed lines drawn on the armature 10 represent the cross-sectional shape of both end portions of a core 11 in the Z-axis direction.

The armature 10 is arranged so as to face each of the field magnet portions 20A and 20B in the positive Z-axis direction and the negative Z-axis direction through a predetermined air gap AG. In this example, the armature 10 is a movable element. The armature 10 is supported movably in the X-axis direction by a support mechanism such as a slide rail or a linear guide. Thus, the armature 10 can be moved in the X-axis direction by a magnetically acting force with the field magnet 20. The armature 10 includes a core (also referred to as an “iron core”) 11, a coil (also referred to as a “winding”) 12, and a holding portion 13.

The core 11 functions as a magnetic path for a magnetic field generated by the armature current of the coil 12 and a magnetic field from the permanent magnet 21 of the field magnet 20. The core 11 is formed of a soft magnetic material. The soft magnetic material used for the core 11 is, for example, an iron-based material such as cast iron or structural steel. The soft magnetic material used for the core 11 may be a functional material such as an electromagnetic steel sheet or a dust core. In this example, a plurality (six) of cores 11 as many as the coils 12 are provided.

For example, as illustrated in FIGS. 1 and 2, the core 11 has a prismatic shape extending in the Z-axis direction, and is formed so that the cross-sectional shape of both end portions in the Z-axis direction is larger than the cross-sectional shape of the central portion in the Z-axis direction. Thus, for example, even if the core 11 attempts to move in the Z-axis positive direction, the end portion of the core 11 in the negative Z-axis direction contacts the holding portion 13, and as a result, the core 11 cannot move in the Z-axis positive direction, so that the core 11 can be prevented from falling out of the armature 10 in association with the movement in the Z-axis positive direction. Also, the core 11 can be prevented from falling out of the armature 10 in association with the movement in the negative Z-axis direction by the same function.

The coil 12 generates a thrust of the movable element (the armature 10) by interaction with a magnetic field generated from the field magnet portions 20A and 20B when an armature current flows. The coil 12 is constituted by winding a conductor around the core 11.

In this example, a plurality (six) of coils 12 are provided. The plurality of coils 12 are arranged in the X-axis direction. For example, three-phase AC power of U-phase, V-phase, and W-phase is supplied to the plurality of coils 12. More specifically, three-phase AC power may be supplied in the order of U-phase (+), U-phase (−), V-phase (−), V-phase (+), W-phase (+), and W-phase (−) from the coils 12 at the end portion in the negative X-axis direction in the figure towards the positive X-axis direction.

An insulating portion (not illustrated) is provided between the core 11 and the coils 12 (conductors) to ensure mutual insulation. The insulating portion is an insulating member such as insulating paper, an insulator, a bobbin, and an insulating coating on the surface of the core 11 to ensure insulation between the core 11 and the coil 12 as a whole. The insulating coating of the core 11 is, for example, an insulating powder coating. The insulating portion may be an insulating film coated on the conductors of the coils 12.

The holding portion 13 integrally holds the plurality of cores 11 and the plurality of coils 12. The holding portion 13 is made of, for example, mold resin, and both end portions of the plurality of cores 11 in the axial direction (Z-axis direction) are held so as to be exposed from the holding portion 13. Further, both end portions of the plurality of cores 11 in the axial direction (Z-axis direction) may be covered by the holding portion 13 and held so as not to be exposed from the holding portions 13.

The field magnet 20 generates a magnetic field acting on the armature 10. In this example, the field magnet 20 is a stator. As illustrated in FIG. 1, the field magnet 20 is provided so as to extend in the X-axis direction, and the dimension thereof in the X-axis direction is defined according to the amount of movement in the X-axis direction of the armature 10 acting as a movable element.

The field magnet 20 includes field magnet portions 20A and 20B.

The field magnet portions 20A and 20B are provided so as to extend substantially parallel to each other in the X-axis direction. “Substantially” is intended to allow manufacturing errors, for example, and is used for the same purpose hereinafter. A predetermined interval in the Z-axis direction is provided between the field magnet portions 20A and 20B, and the interval is set to be larger to some extent than the dimension of the armature 10 in the Z-axis direction. For example, the interval between the field magnet portions 20A and 20B corresponds to the dimension of the armature 10 in the Z-axis direction, plus the movable amount of the support mechanism (for example, a slide rail and a linear guide) of the armature 10 in the Z-axis direction and a predetermined allowance. Thus, the armature 10 acting as the movable element can move in the X-axis direction without coming into contact with the field magnet portions 20A and 20B.

The field magnet portions 20A and 20B are arranged so as to face each other in the positive Z-axis direction and the negative Z-axis direction when viewed from the armature 10. The field magnet portions 20A and 20B generate magnetic fluxes that interlink the coils 12 of the armature 10.

The field magnet portions 20A and 20B include a plurality of permanent magnets 21, a back yoke 22, and a soft magnetic member 23.

The plurality of permanent magnets 21 are arranged in a row in the X-axis direction so as to face the armature 10 in the Z-axis direction. For example, as illustrated in FIG. 1, the plurality of permanent magnets 21 each have a substantially rectangular parallelepiped shape having sides in the X-axis direction, the Y-axis direction, and the Z-axis direction, and are arranged in a row at substantially equal intervals in the X-axis direction. The plurality of permanent magnets 21 are arranged so that the field magnet 20 is magnetized in the Z-axis direction facing the armature 10, and the magnetic pole of the end face in the Z-axis direction facing the armature 10 is different from that of the other permanent magnets 21 adjacent to each other in the X-axis direction.

The permanent magnets 21 are rare earth-free, that is, permanent magnets that do not use any rare earth elements. For example, the permanent magnets 21 are lanthanum-free, that is, ferrite magnets that do not use lanthanum. The permanent magnets 21 may be rare metal-free, that is, permanent magnets that do not use any rare metals including rare earth elements. For example, the permanent magnets 21 are lanthanum-free and cobalt-free, that is, ferrite magnets that do not use lanthanum or cobalt at all.

The field magnet portions 20A and 20B are configured so that the permanent magnets 21 are substantially the same in terms of the magnetic specifications (for example, shape, dimensions, residual magnetic flux density, etc.) and arrangement specifications (for example, the arrangement position of the permanent magnet 21 in the X-axis direction, the arrangement method including the presence or absence of Halbach arrangement, etc.). Thus, the field magnet portions 20A and 20B can generate substantially symmetrical magnetic fields in spaces that face each other in the Z-axis direction.

The back yoke 22 is arranged adjacent to the end face of the permanent magnet 21 on the side opposite to the side where the armature 10 exists in the Z-axis direction. The back yoke 22 functions as a magnetic path between adjacent permanent magnets 21. The back yoke 22 is formed of a soft magnetic material. The soft magnetic material used for the back yoke 22 is, for example, an iron-based material such as cast iron or structural steel. The soft magnetic material used for the back yoke 22 may be a functional material such as an electromagnetic steel sheet or a powder core.

The soft magnetic member 23 is formed of a soft magnetic material and is arranged adjacent to the permanent magnets 21 between adjacent permanent magnets 21 in the X-axis direction. The soft magnetic material is, for example, an iron-based material such as cast iron or structural steel. The soft magnetic material may be a functional material such as an electromagnetic steel sheet or a powder core. For example, as illustrated in FIG. 1, the soft magnetic member 23 has a substantially rectangular parallelepiped shape having sides in the X-axis direction, the Y-axis direction, and the Z-axis direction, and contacts the permanent magnet 21 at both end portions in the X-axis direction. Thus, the field magnet portions 20A and 20B can have saliency in which the magnetoresistance (reluctance) of the magnetic field of the armature 10 is non-uniform in the X-axis direction, which is the moving direction of the movable element (the armature 10). Therefore, the linear motor 1 can use not only the magnet force between the armature 10 and the field magnet 20 but also the reluctance force as the propulsion force. Therefore, the thrust of the linear motor 1 can be increased. Moreover, by using the saliency of the field magnet 20 (the field magnet portions 20A, 20B), the position of the movable element (the armature 10) in the X-axis direction can be estimated, and sensors such as encoders for detecting the position of the armature 10 can be omitted.

The number of magnetic poles and the number of slots of the linear motor 1 may be any combination. For example, as illustrated in FIG. 1, the permanent magnets 21 of the field magnet 20 and the coils 12 of the armature 10 are arranged in a relationship of 5 poles and 6 slots in the X-axis direction. Specifically, in the X-axis direction, the permanent magnets 21 and the coils 12 are arranged so that the number of coils 12 (number of slots) is 6 for a section in which the number of permanent magnets 21 (number of magnetic poles) is 5. The combination of the number of magnetic poles and the number of slots of the linear motor 1 may be 2 poles and 3 slots, 4 poles and 3 slots, 7 poles and 6 slots, or the like, instead of 5 poles and 6 slots.

### [Outline of Linear Motor Position Estimation Method]

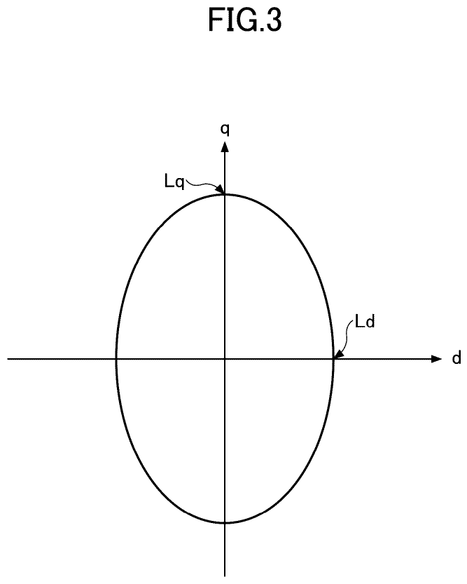

Next, an outline of a position estimation method of the linear motor 1 will be described with reference to FIG. 3.

FIG. 3 is a diagram schematically illustrating an inductance trajectory of the linear motor 1.

The inductance trajectory is obtained by plotting the inductance of the linear motor 1 for one pitch cycle (phase 360 degrees) in the X-axis direction as a vector trajectory on the dq coordinate, where the magnetic pole position of the permanent magnet 21 is the d-axis and the position of the soft magnetic member 23 is the q-axis. The inductance value is calculated from the voltage applied to the armature 10 of the linear motor 1 and the current flowing through the armature 10 at that time.

The control system of the linear motor 1 includes a driving device (not illustrated) and a control device.

The driving device supplies power to the linear motor 1 to drive the linear motor 1. The driving device, which is, for example, a power converting device, generates a three-phase alternating current of a predetermined voltage and frequency from a direct current or an alternating current supplied from an external power supply and supplies the three-phase alternating current to the armature 10 of the linear motor 1 to drive the linear motor 1.

The control device controls the driving device to drive the linear motor 1.

As described above, the control device estimates the position of the armature 10 as a movable element in the X-axis direction by using the saliency of the field magnet 20. Thus, the control device can calculate the estimated value of the speed of the armature 10 based on the estimated value of the position of the armature 10 in the X-axis direction. The control device can control the position and the speed of the armature 10 based on the estimated value of the position of the armature 10 in the X-axis direction and the speed in the X-axis direction.

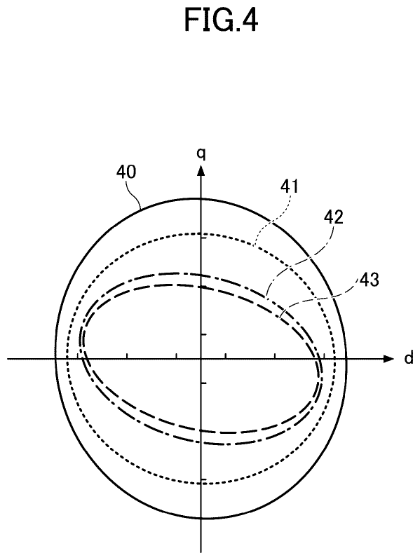

As illustrated in FIG. 4, the inductance characteristic of the salient linear motor 1 is represented by an elliptical inductance trajectory having the d-axis as the short side and the q-axis as the long side. The control device can estimate the position of the armature 10 in the X-axis direction by assuming such an inductance trajectory.

For example, the control device assumes the γ-axis and the δ-axis corresponding to the d-axis and the q-axis, and applies an alternating voltage for high-frequency position detection in the γ-axis direction. At this time, an interference current i_{δ} is generated in the direction of the δ-axis orthogonal to the γ-axis, and the current is becomes 0 (zero) when the γ-axis and the d-axis coincide. Therefore, the control device adjusts the Y-axis and the δ-axis so that the interference current iδ becomes 0 and so that the γ-axis coincides with the d-axis. As a result, the position in the X-axis direction corresponding to the γ-axis can be estimated as the magnetic pole position.

### [Change in Inductance Characteristics of a Linear Motor According to a Comparative Example]

Next, a change in inductance characteristics of a linear motor according to a comparative example will be described with reference to FIG. 4.

FIG. 4 is a diagram illustrating changes in the inductance trajectory in association with changes in the current conditions of the linear motor according to the comparative example.

In FIG. 4, the inductance trajectories 40 to 43 under different current conditions of the linear motor according to the comparative example are drawn, and the armature current increases in the order of the inductance trajectory 40, the inductance trajectory 41, the inductance trajectory 42, and the inductance trajectory 43.

As illustrated in FIG. 4, in the inductance trajectory of the linear motor according to the comparative example, the phase in which the inductance becomes minimum is shifted from the d-axis according to an increase in the armature current. This is because magnetic saturation occurs according to an increase in the armature current, and mutual interference between the d-axis and the q-axis occurs. As a result, in the inductance trajectory of the linear motor according to the comparative example, the positions of the long axis and the short axis are inclined from the d-axis and the q-axis when the armature current is relatively large.

For example, in the linear motor according to the comparative example, when the above position estimation method is performed in a state where the armature current is relatively large, the control device estimates the position corresponding to the short axis of the inclined inductance trajectory, not the d-axis, as the magnetic pole position. Therefore, a relatively large error occurs between the actual magnetic pole position and the estimation result, and as a result, there is a possibility that the control performance is degraded or, in the worst case, the control fails.

### [Structure of Linear Motor]

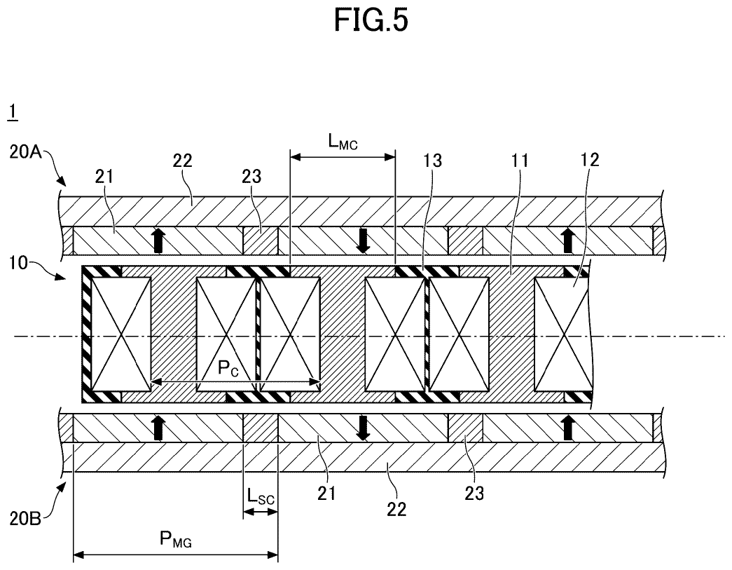

Next, the structure of the linear motor 1 according to the present embodiment will be described with reference to FIGS. 5 to 7.

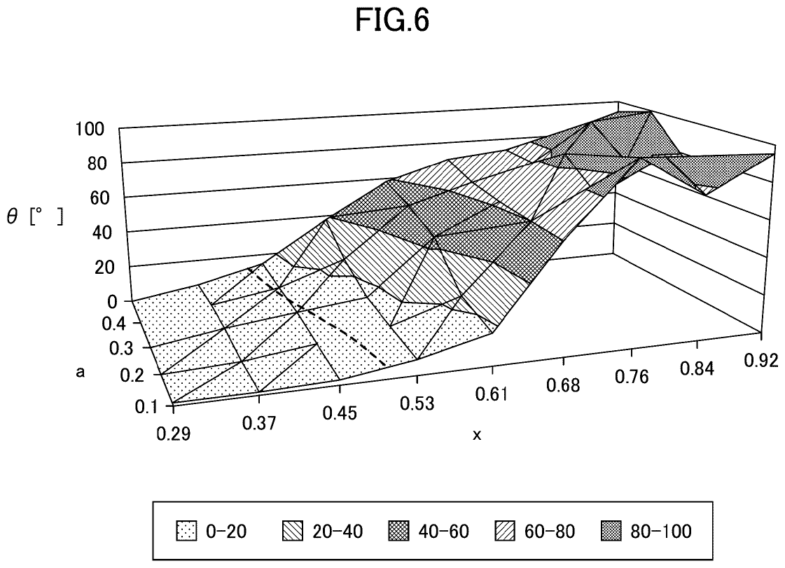

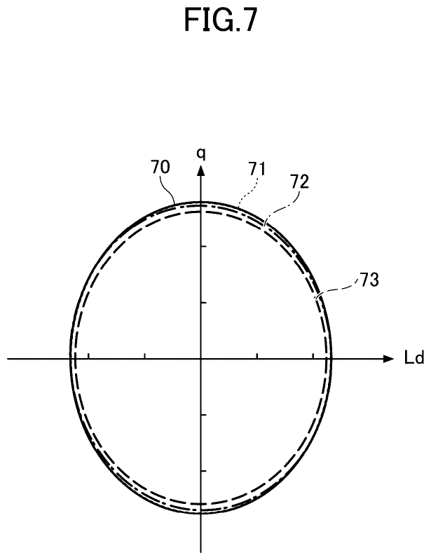

FIG. 5 is a diagram for explaining the dimensions of the components of the linear motor 1 related to the inductance characteristics of the linear motor 1. FIG. 6 is a diagram illustrating an example of the analysis results concerning the relationship between the ratio “x” of the width L_{MC} of the end portion of the core 11 in the Z-axis direction with respect to the coil pitch P_{C} and the ratio “a” of the length L_{SC} of the soft magnetic member 23 with respect to the magnetic pole pitch P_{MG} and the inclination θ of the inductance trajectory of the linear motor 1 under specific current conditions. FIG. 7 is a diagram illustrating the change of the inductance trajectory of an example of the linear motor 1 in association with the change of the current conditions.

Note that the specific current conditions correspond to current conditions of medium to high load in which the inclination θ of the inductance trajectory tends to increase due to magnetic saturation or the like, that is, current conditions in which a relatively large armature current flows.

As illustrated in FIG. 5, the coil pitch P_{C} represents the pitch of the arrangement of the coils 12 in the X-axis direction. The width L_{MC} of the end portion of the core 11 in the Z-axis direction represents the dimension in the X-axis direction of the end portion of the core 11 in the Z-axis direction. The magnetic pole pitch P_{MG} represents the pitch of the arrangement of the permanent magnets 21 in the X-axis direction. The length L_{SC} of the soft magnetic member 23 represents the dimension of the soft magnetic member 23 in the X-axis direction.

As illustrated in FIG. 6, it can be seen that the inclination θ of the inductance trajectory of the linear motor 1 is greatly influenced by the ratio “x” (=L_{MC}/P_{C}). Specifically, the inclination θ of the inductance trajectory of the linear motor 1 increases as the ratio “x” increases. The relatively large ratio “x” indicates that the width L_{MC} of the end portion of the core 11 in the Z-axis direction is relatively large. In this case, the magnetic flux tends to concentrate in the core 11, and thus magnetic saturation of the coil 12 tends to occur.

In particular, in a range where the ratio “x” exceeds 0.53 to 0.61, the inclination θ of the inductance trajectory exceeds 20° and rapidly increases according to an increase in the ratio “x”. Therefore, for example, the structure of the linear motor 1 is determined such that the ratio “x” is 0.53 or less.

As illustrated in FIG. 6, it can be seen that the inclination θ of the inductance trajectory of the linear motor 1 has an effect of the ratio “a” (=L_{SC}/P_{MG}) in addition to the effect of the ratio “x”. Specifically, the inclination θ of the inductance trajectory of the linear motor 1 increases as the ratio “a” increases. The relatively large ratio “a” indicates that the length L_{SC} of the soft magnetic member 23 is relatively large. In this case, the magnetic flux interlaced with the coil 12 through the soft magnetic member 23 becomes relatively large, and thus the magnetic saturation of the coil 12 tends to occur.

Therefore, the condition related to the ratio “x” may be determined in consideration of the ratio “a”. For example, the structure of the linear motor 1 is determined so that the condition of the following expression (1), which represents the relationship between the ratio “x” and the ratio “a”, is satisfied.

$$\begin{matrix}[ Expression 1 ] & \\ x \leq - 0.184 a + 0.518 & ( 1 )\end{matrix}$$

The upper limit of the ratio “x” defined by the expression (1) is represented by a broken line in FIG. 6. Thus, as the ratio “a” becomes larger, the upper limit of the ratio “x” (broken line in FIG. 6) becomes smaller, so that the inclination θ of the inductance trajectory of the linear motor 1 can be more appropriately reduced.

For example, FIG. 7 illustrates the inductance trajectory 70 to 73 of the linear motor 1 under different current conditions, and the armature current increases in the order of the inductance trajectory 70, the inductance trajectory 71, the inductance trajectory 72, and the inductance trajectory 73.

In this example, by appropriately determining the ratio “x” of the width L_{MC} of the end portion of the core 11 in the Z-axis direction with respect to the coil pitch P_{C}, even if the armature current increases, the inclination θ of the inductance trajectory of the linear motor 1 can be reduced to be very small.

Thus, in this example, by appropriately determining the ratio “x” of the width L_{MC} of the end portion of the core 11 in the Z-axis direction with respect to the coil pitch P_{C} in the linear motor 1, the magnetic saturation of the linear motor 1 from the medium load to the high load can be prevented, and the inclination θ of the inductance trajectory can be reduced. Therefore, the control device can maintain the estimation accuracy of the position in the X-axis direction of the armature 10 at a relatively high level, and as a result, the position control and the speed control of the linear motor 1 can be more appropriately executed.

### Another Embodiment

Next, another embodiment will be described.

Modifications and changes may be made to the above-described embodiment as appropriate.

Further, in the above-described embodiment and examples of modifications and changes thereof, the permanent magnet 21 may be a permanent magnet using a rare earth or a rare metal. For example, the permanent magnet 21 may be a neodymium magnet or a ferrite magnet using cobalt or lanthanum.

Further, in the above-described embodiment and examples of modifications and changes thereof, in the case where the permanent magnet 21 and the coils 12 are arranged in a relationship of 5 poles and 6 slots in the X-axis direction, the number of the coils 12 of the armature 10 may be a multiple of 6 over 7. The same applies to the case where the combination of the number of magnetic poles and the number of slots of the linear motor 1 is 3 slots with 2 poles, 3 slots with 4 poles, 6 slots with 7 poles, etc.

Further, in the above-described embodiment and examples of modifications and changes thereof, the back yoke 22 and the soft magnetic member 23 may be formed as a single member.

Further, in the above-described embodiment and examples of modifications and changes thereof, the back yoke 22 may be omitted.

Further, in the above-described embodiment and examples of modifications and changes thereof, the cross-sectional shape of the core 11 at both end portions in the Z-axis direction may be substantially the same as the cross-sectional shape of the central portion in the Z-axis direction.

Further, in the above-described embodiment and examples of modifications and changes thereof, the armature 10 may be a stator and the field magnet 20 may be a movable element in the linear motor 1. In this case, the armature 10 is provided so as to extend between both end portions of the movable range in the X-axis direction. In this case, the field magnet portions 20A and 20B of the field magnet 20 are connected so as to surround the armature 10 in the Z-axis direction and the Y-axis direction.

Further, in the above-described embodiment and examples of modifications and changes thereof, the moving path of the movable element of the linear motor 1 may include at least a path along a curve.

### [Function]

Next, the function of the linear motor according to the present embodiment will be described.

In the present embodiment, the linear motor includes an armature and a field magnet arranged to face each other so as to enable relative movement. The linear motor is, for example, the linear motor 1 described above. The armature and the field magnet are, respectively, the armature 10 and the field magnet 20 described above. Specifically, the armature includes a plurality of windings, each wound around a first core, arranged along the direction of relative movement of the armature and the field magnet. The first core is, for example, the core 11 described above. The winding is, for example, the coil 12 described above. The direction of relative movement of the armature and the field magnet is, for example, the X-axis direction described above. The field magnet includes a plurality of permanent magnets and a plurality of second iron cores. The permanent magnet is, for example, the permanent magnet 21 described above. The second iron core is, for example, the soft magnetic member 23 described above. More specifically, the plurality of permanent magnets are arranged so as to face the armature in a direction orthogonal to the direction of relative movement of the armature and the field magnet, and are arranged along the direction of relative movement of the armature and the field magnet. The direction orthogonal to the direction of relative movement of the armature and the field magnet is, for example, the Z-axis direction described above. The plurality of second iron cores are arranged so as to be alternately arranged with the permanent magnets along the direction of relative movement. In the direction of relative movement of the armature and the field magnet, the first ratio of the dimension of the portion of the first iron core facing the field magnet with respect to the pitch at which the windings are arranged may be 0.53 or less. The pitch at which the windings are arranged is, for example, the coil pitch P_{C} described above. The dimension of the portion of the first iron core facing the field magnet is, for example, the width L_{MC} described above. The first ratio is, for example, the ratio “x” described above.

This makes it possible to make the dimension of the portion of the first iron core facing the field magnet relatively small. Therefore, it is possible to prevent magnetic saturation of the winding and reduce the inclination of the inductance trajectory in an operating state in medium to high load when the armature current of the linear motor is relatively large. As a result, it is possible to improve the accuracy of estimating the position of the moving element of the linear motor. Therefore, the performance of the sensorless control of the linear motor can be improved from the structural aspect.

In the present embodiment, the above relational expression (1) may be satisfied when the first ratio is “x” and the second ratio of the dimension of the second iron core to the pitch at which the plurality of permanent magnets are arranged in the direction of relative movement of the armature and the field magnet is “a”. The pitch at which the plurality of permanent magnets are arranged is, for example, the above-described magnetic pole pitch P_{MG}. The dimension of the second core is, for example, the length L_{SC} of the above-described second core. The second ratio is, for example, the above-described ratio “a”.

Thus, the first ratio is determined so that the larger the second ratio, the smaller the first ratio. Therefore, even when the magnetic flux linking the winding through the second core is relatively large because the second ratio is relatively large, the first ratio is determined so as to be relatively small according to the second ratio, thereby preventing magnetic saturation of the winding in the operating state in medium to high load. Therefore, the accuracy of estimation of the position of the movable element of the linear motor can be further improved.

Further, in the present embodiment, the dimension of the portion of the first core facing the field magnet may be larger than the dimension of the other portions in the direction facing the field magnet.

Thus, for example, the ratio “x” can be adjusted to make the dimension of the portion of the first iron core facing the field magnet relatively small, and to prevent the dropping of the first iron core from the armature.

Further, in the present embodiment, the permanent magnet may be made of a rare-earth free material.

Thus, a linear motor can be configured by using a permanent magnet having a rare-earth free residual magnetic flux density that is relatively small.

Further, in the present embodiment, the permanent magnet may be made of rare-metal free material.

Thus, a linear motor can be configured by using a permanent magnet having a rare-metal free residual magnetic flux density that is relatively small.

In the present embodiment, the permanent magnet may be a lanthanum-free and cobalt-free ferrite magnet.

Thus, a linear motor can be configured by using a lanthanum-free and cobalt-free ferrite magnet having a relatively small residual magnetic flux density.

Although the above embodiments have been described in detail, the present disclosure is not limited to such a specific embodiment, and various modifications and changes are possible within the scope of the claims.

What is claimed is:

1. A linear motor comprising:
an armature; and
a field magnet, the armature and the field magnet being arranged to face each other such that relative movement is possible, wherein
the armature includes a plurality of windings, each of which being wound around a first iron core and arranged along a direction of the relative movement,
the field magnet is arranged to face the armature in a direction orthogonal to the direction of the relative movement, and includes a plurality of permanent magnets arranged along the direction of the relative movement, and a plurality of second iron cores arranged to alternate with the permanent magnets along the direction of the relative movement, and
a first ratio of a dimension of a portion of the first iron core facing the field magnet with respect to a pitch at which the windings are arranged in the direction of the relative movement, is less than or equal to 0.53.

2. The linear motor according to claim 1, wherein when the first ratio is “x” and a second ratio of a dimension of the second iron core with respect to a pitch at which the plurality of permanent magnets are arranged in the direction of the relative movement is “a”, a following relational expression is satisfied: x≤−0.184a+0.518.

3. The linear motor according to claim 1, wherein in a direction facing the field magnet, the dimension of the portion of the first iron core facing the field magnet is larger than a dimension of other portions of the first iron core.

4. The linear motor according to claim 1, wherein the permanent magnet is configured to be rare-earth-free.

5. The linear motor according to claim 4, wherein the permanent magnet is configured to be rare-metal-free.

6. The linear motor according to claim 5, wherein the permanent magnet is a lanthanum-free and cobalt-free ferrite magnet.
